(19) United States
(12) Patent Application Publication
(10) Pub. No.: US 2016/0283934 A1
(43) Pub. Date: Sep. 29, 2016

(54) WATCH WITH NEAR FIELD COMMUNICATION CHIP AND THE METHOD OF TRANSACTION

(71) Applicant: Mass International Co., Ltd., Apia (WS)

(72) Inventors: Yi-Chuan CHENG, Yongjing Township (TW); Kuo-Ching CHIANG, New Taipei City (TW)

(21) Appl. No.: 14/666,272

(22) Filed: Mar. 23, 2015

(51) Int. Cl. G06Q 20/32; G06Q 20/38

(52) U.S. Cl. CPC G06Q 20/3278; G06Q 20/3223; G06Q 20/3229; G06Q 20/385

(57) ABSTRACT

A watch or other type of portable electronic console employs a number of different functions in order to improve its usability. The watch with a near field communication (NFC) chip and at least one antenna may allow a user to connect to a card reader for conducting a transaction. Still further, the watch wirelessly contacting to a smart phone may allow a user to connect to a card reader for conducting a transaction of credit card.

### TECHNICAL FIELD

The present invention relates to a watch device, and more particularly, to a watch device with a near field communication (NFC) chip and a transmitter for transaction with a contact-less card reader.

### BACKGROUND

Various aspects relate to an adaptive watch for athletic use. More particularly, various aspects relate to a watch or other portable electronic console that allows a user to connect the watch to one or more sensors or other remote electronic devices, such as a heart rate monitor, a speed/distance monitor, a blood pressure monitor, a global positioning device or even a digital music player, such that the watch displays information relating to the connected electronic devices.

However, watch's usage is limited to the above-mentioned applications. Thus, the present invention is introduced to further applications absent from the aforementioned situations.

### SUMMARY

The present application proposes a watch device with a near field communication (NFC) chip and at least one antenna which allows a user to connect to a contact-less card reader for conducting a transaction.

According to one aspect of the invention, a method of contact-less transaction comprises implanting a contact-less card including a transaction card, a credit card or a cash card into a mobile terminal. A watch device is provided with a transmitter and a near field communication chip, wherein the watch device is wirelessly contacting to the mobile terminal within a predetermined distance. The watch device is contact-lessly attaching to a contact-less card reader for transmitting a transaction signal from the transmitter to process a contact-less transaction.

The contact-less card is an independent card to a SIM card or is integrated with the SIM card. The transmitter is an antenna or coils set.

According to one aspect of the invention, the method further comprises a step of displaying a transaction information on a display of the mobile terminal or a display of the watch device, and downloading a transaction information through a wireless data transferring module of the mobile terminal.

The mobile terminal is a cell phone, a smart phone, a Personal Digital Assistant or a tablet PC. The mobile terminal includes a SIM for identifying a subscriber of the mobile terminal. The contact-less card is coupled to the SIM in order to identify the transaction.

According to another aspect of the invention, the watch device further comprises a memory coupled to the control unit. The watch device further comprises a wireless data transferring module and an image capture module coupled to the control unit.

According to one aspect of the invention, the method further comprises a step of generating a security code by a security code generator in the watch device or the mobile terminal. The security code is a one time password generated by the watch device or the mobile terminal.

According to one aspect of the invention, a method of contact-less transaction comprises providing a mobile terminal and a watch device which communicates with the mobile terminal. Next, a contact-less card including a transaction card, a credit card or a cash card is implanted into the watch device, wherein the watch device includes a transmitter and a near field communication chip, wherein the watch device is wirelessly contacting to the mobile terminal within a predetermined distance. Then, the watch device is contact-lessly attaching to a contact-less card reader for transmitting a transaction signal from the transmitter to process a contact-less transaction.

According to one aspect of the invention, the method further comprises a step of transferring an image captured by the watch device to the mobile terminal by a wireless data transferring module.

The foregoing and other objects, features, and advantages of the invention will become more apparent from the following detailed description, which proceeds with reference to the accompanying figures.

### BRIEF DESCRIPTION OF THE DRAWINGS

The components, characteristics and advantages of the present invention may be understood by the detailed descriptions of the preferred embodiments outlined in the specification and the drawings attached:

FIG. 1 is an example of a portable device of the present invention;

FIG. 2 illustrates input devices/output devices of the FIG. 1;

FIG. 3 illustrates a functional diagram depicting a watch device according to one embodiment of the present invention;

FIG. 4 illustrates a functional diagram depicting a watch device communicating with a contactless reader according to one embodiment of the present invention;

FIG. 5 illustrates a functional diagram depicting a watch device communicating with a portable device according to one embodiment of the present invention.

### DETAILED DESCRIPTION

Some preferred embodiments of the present invention will now be described in greater detail. However, it should be recognized that the preferred embodiments of the present invention are provided for illustration rather than limiting the present invention. In addition, the present invention can be practiced in a wide range of other embodiments besides those explicitly described, and the scope of the present invention is not expressly limited except as specified in the accompanying claims.

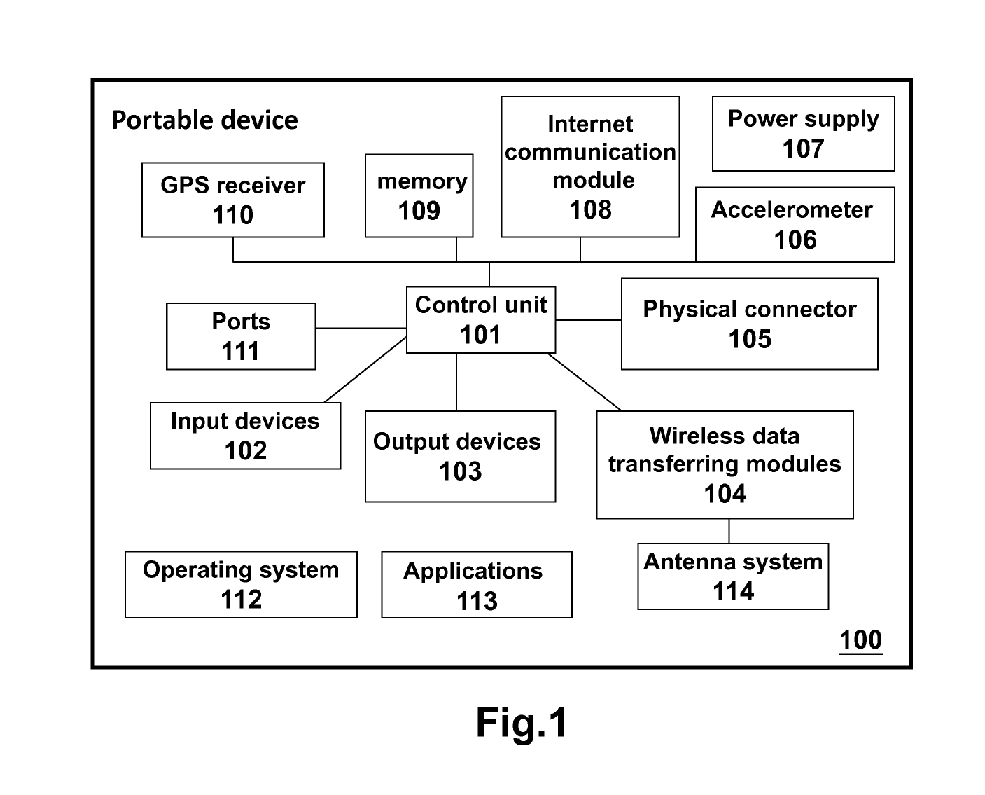

FIG. 1 is a functional diagram depicting an exemplary mobile terminal (portable device) 100 including a variety of optional hardware and software components. Any components in the mobile device can communicate with any other component, although not all connections are shown, for ease of illustration. The mobile terminal (portable device) 100 can be any of a variety of computing devices (e.g., cell phone, smart phone, Personal Digital Assistant (PDA), tablet etc.) and can allow wireless two-way communications with one or more mobile communications networks, such as a cellular or satellite network.

The illustrated portable device 100 can include a controller (control IC) or processor 101 (e.g., signal processor, microprocessor, ASIC, or other control and processing logic circuitry) for performing such tasks as signal coding, data processing, input/output processing, power control, and/or other functions. An operating system 112 can control the allocation and usage of the components and support for one or more application programs 113. The application programs 113 can include common mobile computing applications (e.g., email applications, calendars, contact managers, web browsers, messaging applications), or any other computing application.

The illustrated portable device 100 can include memory 109 which can include non-removable memory and/or removable memory. The non-removable memory can include RAM, ROM, flash memory, a hard disk, or other well-known memory storage technologies. The removable memory can include flash memory or a Subscriber Identity Module (SIM) card, which is well known in GSM communication systems, or other well-known memory storage technologies, such as “smart cards”. The memory can be used for storing data and/or code for running the operating system 112 and the applications 113. Example data can include web pages, text, images, sound files, video data, or other data sets to be sent to and/or received from one or more network servers or other devices via one or more wired or wireless networks. The memory can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

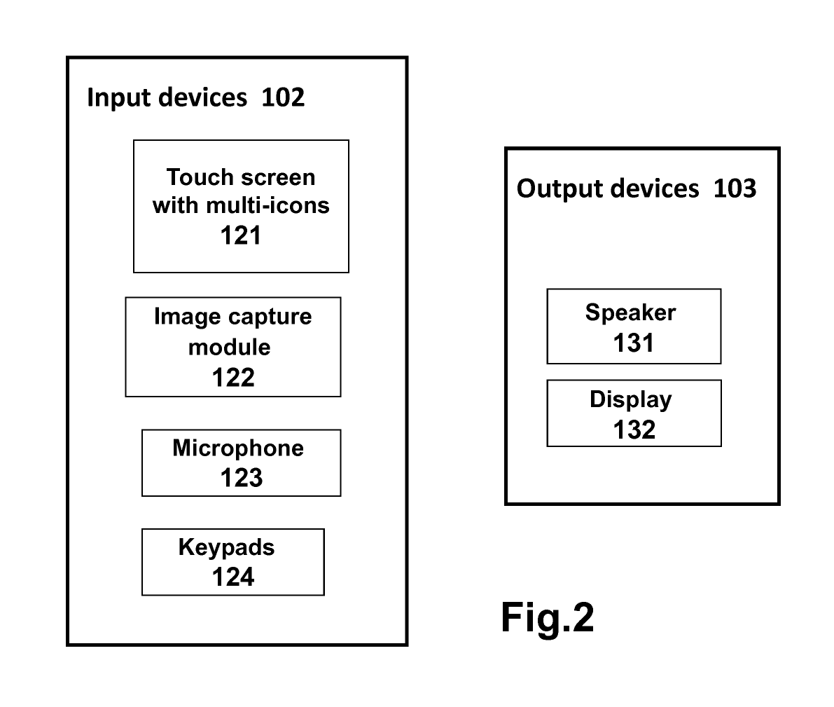

The portable device 100 can support one or more input devices 102, such as a touch screen 121, image capturing module (camera) 122, microphone 123 and keypads 124, and one or more output devices 103, such as a speaker 131 and a display 132, shown in FIG. 2. Some devices can serve more than one input/output function. For example, touch screen 121 and display 132 can be combined in a single input/output device. The touch screen 121 can support multiple functional icons. The icons can be displayed on a home (touch) screen, which is typically the screen displayed when the portable device is powered on. The home screen is the base screen that generally cannot be further minimized and that contains icons representing applications. As further described below, each icon is represented by an image based on its respective application.

The portable terminal or device 100 includes at least one wireless data transferring modules 104. The first wireless data transferring module 104 could be video RF module to transmit or receive mobile phone signal and it is well known in the art. As known in the art, the RF unit is coupled to an antenna system 114. The RF module may include base band processor and so on. This antenna is connected to a transceiver, which is used to receive and transmit signal. The first wireless data transferring modules 104 is compatible to the mobile phone protocol such as W-CDMA CDMA2000 CDMA2001 TD-CDMA TD-SCDMA UWC-136 DECT 4G system. There systems allow the user communicates with video communication. The RF module may perform the function of signal transmitting and receiving, frequency synthesizing, base-band processing and digital signal processing. The SIM card hardware interface is used for receiving a SIM card. Finally, the signal is send to the final actuators, i.e. a vocal I/O unit 131 including a loudspeaker and a microphone. The module 104 can be formed by separated module (chip) or integrated chip. A wireless data transferring module 104 can be coupled to an antenna and can support two-way communications between the processor 101 and external devices, as is well understood in the art.

The device 100 further includes the second wireless data transferring module 104. In one embodiment, a wireless local area network (WLAN) module is employed and it could be compatible to the local area network protocol or standard such as Bluetooth standard, Wi-Fi standard, or 802.11x (x refers to a, b, g, n) standard compatible module. Further, the wireless local area network (WLAN) module could be compatible to the WiMAX (Worldwide Interoperability for Microwave Access) standard or specification. An Internet communication module 108 are coupled to the central control unit 101 to allow transmit and receive the audio, text, image, video or combination type signal to/from the internet network through the wireless local area wireless transmission module. Internet communication module 108 may meet the standard of terminal-terminal Voice Over Internet Protocol (VoIP). One of the examples is Skype compatible protocol. By using of the Internet communication module 108 and the wireless local area network module 200B, the user may portably, synchronously transmit and receive the vocal, video or both signal through the internet by using the internet (software) phone module 108. The present invention defines a hand-held device having VoIP phone module and wireless WiFi or WiMax network linking module coupled to the VoIP phone module to allow the user to make a wireless terminal-terminal VoIP phone without power on the PC. The voice over internet protocol (VoIP) phone module is used to encode or convert the voice signal into VoIP protocol within the portable communication device before transmitting the signal, followed by programming the signal into WiFi or WiMax format in order to transmit the voice signal through the wireless network, especially, the Skype phone.

The portable device 100 can further include at least one input/output port 111, a power supply 107, a satellite navigation system receiver 110, such as a Global Positioning System (GPS) receiver, an accelerometer 106, and/or a physical connector 105, which can be a USB port, IEEE 1394 (FireWire) port, and/or RS-232 port. The illustrated components are not required or all-inclusive, as any components can deleted and other components can be added. For example, the device 100 may include DSP, CODEC (not shown) and A/D converter as well.

An image capturing module 122 is required and coupled to the central control unit 101 to catch the video image if the user would like to conduct the real-time video transmission. The image capturing module 122 could be digital still camera, digital video camera. Therefore, the real-time portable conference is possible. In another embodiment, the one difference is that the device may omit the RF module. If the device 100 includes 3G or higher level RF module, the user may transmit the video phone through the air. Therefore, the user may select one of the schemes to make a video call through internet or air depending on the user demand. If the device is within the hot spot area, the user may choose the usage of the internet phone module for communication due to cheaper transmitting fee. If the out of the hot spot range, the other option for video communication is provided. Typically, the WCDMA signal is less restricted by the geography limitation, but the transmission fee is higher. The present invention allows the user to select the proper wireless module for video communication. If the user would like to conduct the video communication through WiFi or WiMax, the method includes coupling to internet or hot spot, followed by activating the internet (software) phone module. Subsequently, vocal signal is input from the speaker and image data is captured from the image capture device, subsequently, the image data and the vocal signal are converted from signal to digital. After the conversion, the image data and the vocal signal are composition, compressed or processed to form a data streams.

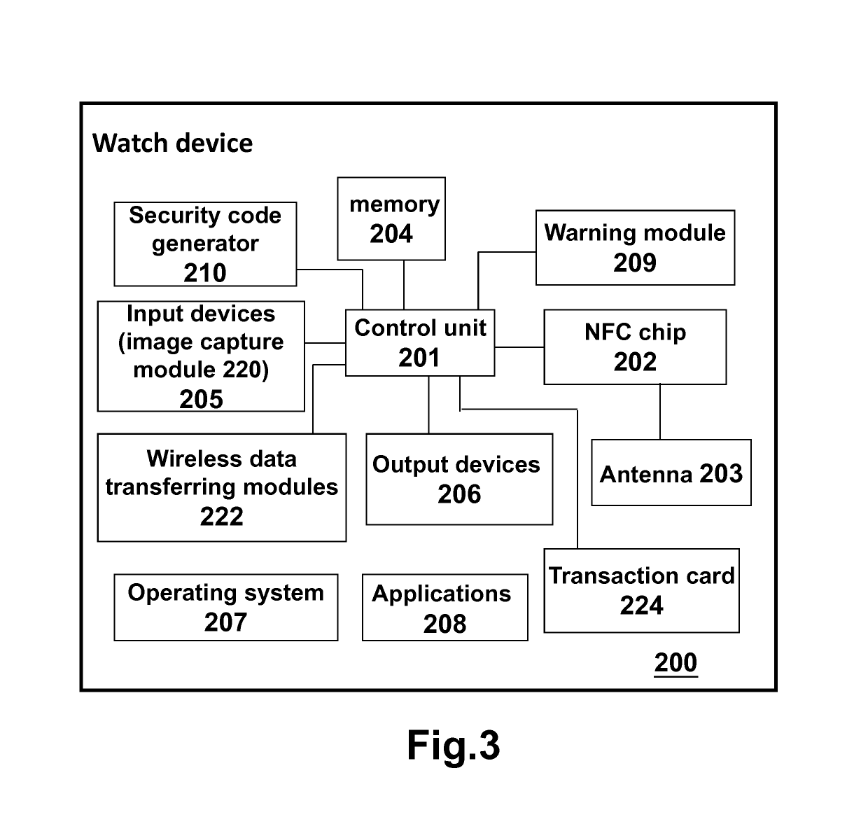

FIG. 3 is a functional diagram depicting a watch device 200 including a variety of optional hardware and software components. Any components in the watch device can communicate with any other component, although not all connections are shown, for ease of illustration. The watch device 100, for example a smart wrist watch, can allow wireless two-way communications with one or more communications modules.

The illustrated watch device 200 can include a controller (control unit; IC) or processor 201 (e.g., signal processor, microprocessor, ASIC, or other control and processing logic circuitry) for performing such tasks as signal coding, data processing, input/output processing, power control, and/or other functions. An operating system 207 can control the allocation and usage of the components and support for one or more application programs 208. The application programs 208 can include common computing applications (e.g., email applications, calendars, contact managers, web browsers, messaging applications), or any other computing application.

The illustrated watch device 200 can include a wireless communication functionality including at least one NFC chip 202, and at least one NFC antenna 203 electrically connected to the NFC chip 202. In one embodiment, a selecting module is electrically connected to the NFC chip 202 and the NFC antenna 203. The NFC antenna 203 is capable of communicating with the external device. Near field communication (NFC) is a set of standards for smart phones and similar devices to establish communication with each other by touching them together or bringing them into close proximity.

The watch device 200 having a near field communication (NFC) antenna includes a display screen, and a printed circuit board (PCB). The display screen has a first surface and an opposite second surface. The PCB is attached on the first surface of the display screen. The NFC antenna includes a number of concentrically wound coils attached on the second surface of the display screen.

The illustrated watch device 200 can include memory 204 which can include non-removable memory and/or removable memory. The removable memory can include flash memory or a Subscriber Identity Module (SIM) card, or other well-known memory storage technologies, such as “smart cards”. The memory can be used for storing data and/or code for running the operating system 207 and the applications 208. Example data can include web pages, text, images, sound files, video data, or other data sets to be sent to and/or received from one or more network servers or other devices via one or more wired or wireless networks. The memory can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The watch device 200 can support one or more input devices 205, such as a touch screen, image capture device (camera), microphone and keypads, and one or more output devices 206, such as a speaker and a display, similar to FIG. 2. Some devices can serve more than one input/output function.

In another embodiment, the watch device 200 includes a wireless data transferring module compatible to the mobile phone protocol, which can be coupled to an antenna and can support two-way communications between the processor 201 and external devices.

In one embodiment, the watch device 200 includes a warning module 209 coupled to the control unit 201. The warning module 209 can be used to detect the distance between the watch device 200 and the portable device 100. When the watch device 200 is far away a predetermined distance from the portable device 100, the warning module 209 sends a warning signal to notice the user of the watch device 200 or the portable device 100. The warning signal is such as audio signal, a video signal or flash light.

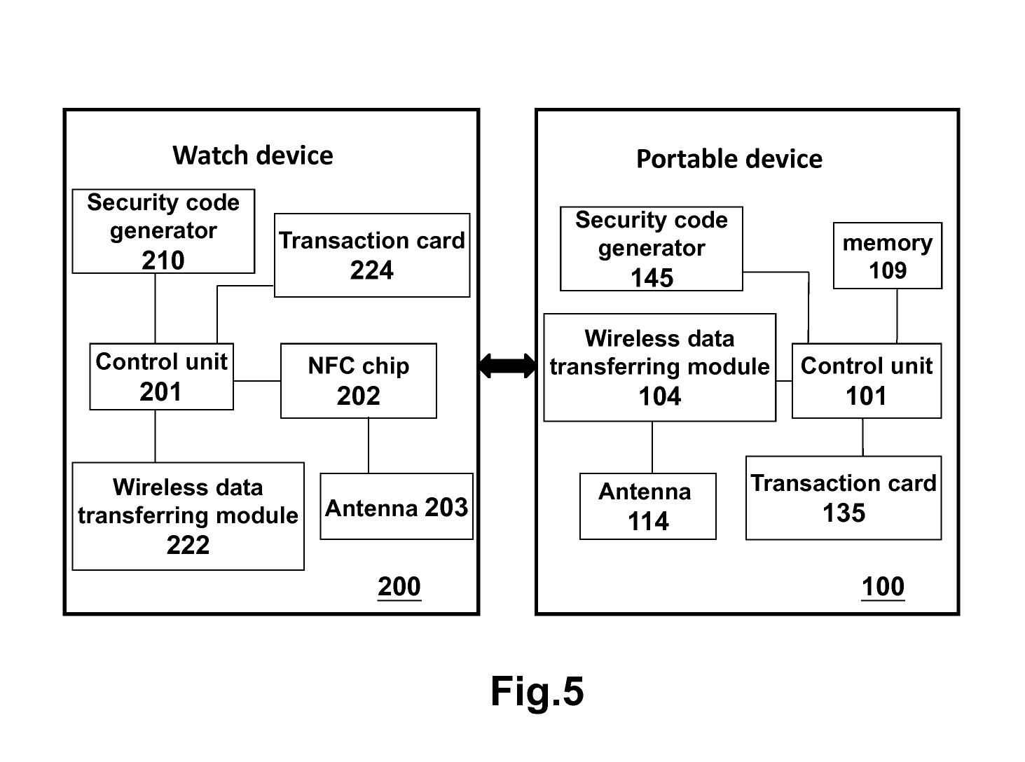

For example, the antenna or resonant coils in the watch device is a near field transaction antenna rather than the RF antenna of the phone. Therefore, the watch device can be used as the transaction tool. The watch device 200 can include a security code generator 210 coupled to the control unit 201. For example, a transaction security code generator 210 may be stored in the memory 204 for verification or identify. Based on the features, it may identify the user of the watch device 200, and the code created by the transaction security code generator 210 can be used to identify the one who deals with the transaction. Alternatively, it is a one-time password (OTP), the OTP is a password that is valid for only one login session or transaction, on a computer system or other digital device. OTPs avoid a number of shortcomings that are associated with traditional (static) password based authentication. Therefore, the users may use the watch embedded with the transaction security code generator 210, the antenna 203 and the NFC chip 202 as the transaction tool for near field transaction. The security code generator 145 may be set in the smart phone 100 and coupled to it's control unit 101, shown in FIG. 5. It may be through the service party for example, communication service company, credit card center or bank to charge the transaction. Otherwise, it may download the credit points from the communication network or internet, the watch acts as the payment tool or virtual cash card. The related information may be displayed and processed by the software in the watch device 200 or the portable device 100, and therefore the transaction record or information could be stored or displayed. The user may be added the credit value into the watch device 200 through POS system or download the coupon through the communication network or internet if the watch device having the wireless module such as WiFi. It may automatically add the electronic cash value when the electronic money below the threshold.

The watch device 200 may have an image capture device (module) 220 coupled to the control unit 201. A wireless data transferring module 222 is coupled to the control unit 201 for communicating with the wireless data transferring module 104. The image captured by the image capture device 220 can be sent to the smart phone 100 through the wireless data transferring module 222. The watch device 200 may have a contact-less transaction card 224 coupled to the control unit 201 which includes a transmitter or the contact-less transaction card is coupled to a transmitter.

In this disclosure of the invention, the contact-less transaction card may be a physical transaction card or a virtual transaction card, whereby user information, bank information, password, account information or transaction information may be stored in flash memory, SIM card, NFC chip, etc. The contact-less transaction card may be embedded into the watch device or the mobile terminal

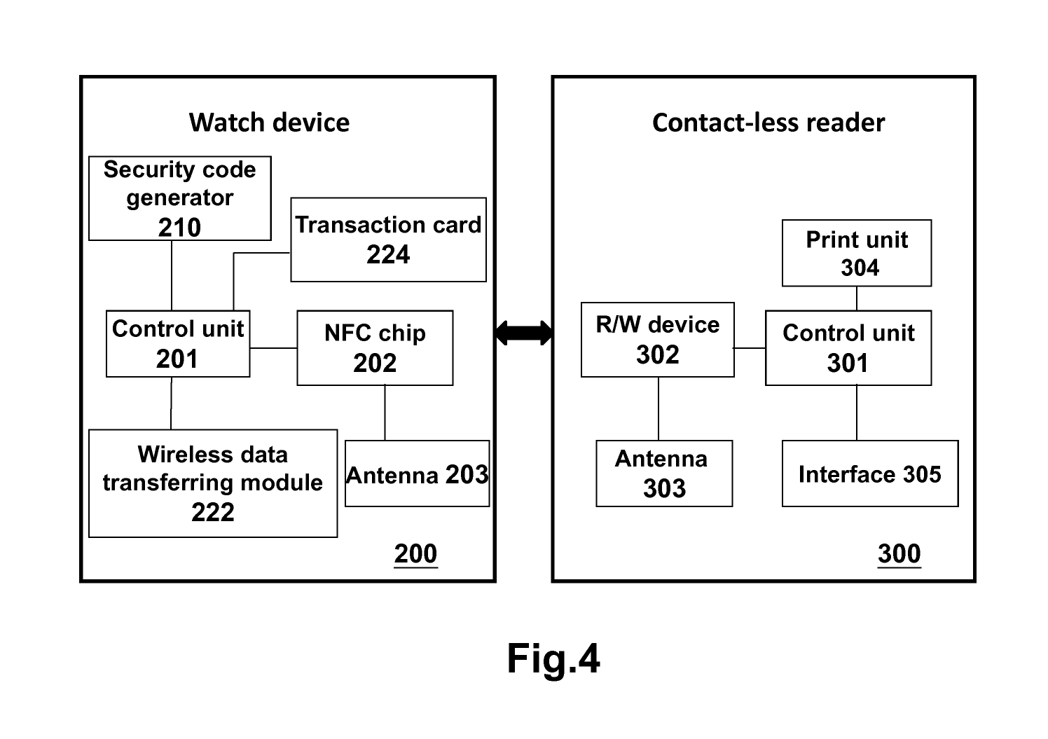

FIG. 4 is a functional diagram depicting a contactless reader 300 including a variety of optional hardware and software components, communicating with the watch device 200. During the operation, the contact-less reader 300 may be supplied by power and generate magnetic field or electronic current to drive the IC for fetching the information stored in the memory. Similarly, the watch device 200 may receive the signal from the contactless reader 300 by electronic-magnetic effect. The antenna or coils 303 of the contactless reader 300 may transmit or receive signal to read/write device 302. A control unit 301 is coupled to the read/write device 302 to process the received or delivered signal. The coils may be replaced by antenna. The contactless card reader 300 or point of sales (POS) may be connected to a terminal server and coupled to the control unit 301 through an internet interface 305 for interchanging the information with the database. A printing unit 304 is optional coupled to the control unit 301 in order to print the transaction receipt. Typically, the contactless or contact card reader is coupled to a computer to engage with the banking service.

The present invention is adaptable to credit card transaction, financial transaction, such as automated teller machine (ATM), card reader, point of sales and personal identify.

The invention may be applied to ATM. Therefore, it is a contact-less ATM including cash drawing unit and/or depositing unit for drawing or depositing money. A control unit is provided to control the input signal and coupled to the main frame (not shown) for transaction identification and data query. A memory may couple to the control unit. A cash storage is used to store cash and coupled to the cash drawing unit and/or depositing unit through cash delivery. The contact-less ATM includes a contact-less read-writer coupled to the contact-less signal transmitter and the control unit for near field wireless transaction. The ATM will couple to the terminal for identification while transaction. It may also include the contact reader for conventional usage. It may couple to the terminal database for information exchange.

FIG. 5 illustrates a functional diagram depicting a watch device communicating with a portable device according to one embodiment of the present invention. The present invention disclosed a transaction method through a mobile terminal such as smart mobile phone, or tablet computer. The method includes the step of implanting a contact-less transaction card, credit card or cash card 135 into the portable (mobile) device 100 such as mobile phone, or tablet. The contact-less transaction card 135 coupled to the control unit 101 includes a transmitter or the contact-less transaction card is coupled to a transmitter. Alternatively, the security code generator is embedded in the mobile device memory or in above IC card to generate the security code which can be displayed on the mobile device display. The user may transact with other party by transmitting transaction signal from the antenna 114 of the mobile device 100 to the antenna 203 of the watch device 200, and followed by transmitting the transaction signal form the antenna 203 of the watch device 200 to the antenna 303 of the contact-less card reader 300. Thus, it can transact with other party by the watch device 200 wirelessly contacting with the contact-less card reader 300, and the mobile device 100 is useless to be taken out of the user during the transaction. The contact-less transaction card is an independent card to the SIM card or it could be integrated with the SIM card. In one case, the antenna or the coils is set within the card, within the SIM card, within the internal of the phone or outside of the phone to avoid the EM shielding effect.

The present invention discloses a contact-less transaction method, it includes steps of providing a transaction card which is contact-less or contact type. The card is interactive with a wired card reader or wireless card reader, and the security code generator is activated by the card reader to generate security code for web banking service. The method includes step of contact-less attaching the credit card to the card reader for transmitting signals contactless, wherein the contact-less transaction card includes IC coupled to the transmitter (antenna). It may store or record the user information or transaction information.

The present invention discloses a contact-less financial transaction method, it includes steps of providing a watch device with a contact-less transaction card and contact-less ATM, wherein the contact-less transaction card and contact-less ATM includes a signal transmitter, respectively. The method includes step of wirelessly attaching the watch device to the ATM for transmitting signals wirelessly to process the transfer, wherein the watch device is wirelessly coupled to the mobile device with a contact-less transaction card in a predetermined distance, depositing or drawing via the contact-less transaction, wherein the contact-less transaction card includes IC coupled to the transmitter (such as antenna or coils). It may store or record the user information, bank information, password, account information or transaction information. The contactless card reader of the ATM provides power to the contact-less card to the security code generator generate security code.

The portable device 100 may be a cell phone, a smart phone, a tablet PC, a digital camera, or a Personal Digital Assistant. The user may enter the password from the watch device or the portable device for transaction security.

It will be understood that the above descriptions of embodiments are given by way of example only and that various modifications may be made by those with ordinary skill in the art. The above specification, examples and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention.

What is claimed is:

1. A method of contact-less transaction, comprising:
implanting a contact-less card including a transaction card, a credit card or a cash card into a mobile terminal;
providing a watch device with a transmitter and a near field communication chip, wherein said watch device is wirelessly contacting to said mobile terminal within a predetermined distance; and
contact-lessly attaching said watch device to a contact-less card reader for transmitting a transaction signal from said transmitter to process a contact-less transaction.

2. The method of claim 1, wherein said contact-less card is an independent card to a SIM card or is integrated with said SIM card.

3. The method of claim 1, wherein said transmitter is an antenna or coils set.

4. The method of claim 1, further comprising displaying a transaction information on a display of said mobile terminal or a display of said watch device.

5. The method of claim 1, further comprising downloading a transaction information through said mobile terminal.

6. The method of claim 1, wherein said mobile terminal is a cell phone, a smart phone, a Personal Digital Assistant or a tablet PC.

7. A method of contact-less transaction, comprising:
implanting a contact-less card including a transaction card, a credit card or a cash card into a mobile terminal;
providing a watch device with a transmitter and a near field communication chip, wherein said watch device is wirelessly contacting to said mobile terminal within a predetermined distance;
contact-lessly attaching said watch device to a contact-less card reader for transmitting a transaction signal from said transmitter to process a contact-less transaction; and
generating a security code by said watch device or said mobile terminal.

8. The method of claim 7, wherein said security code is a one time password.

9. The method of claim 7, wherein said transmitter is an antenna or coils set.

10. The method of claim 7, further comprising displaying said transaction information on a display of said mobile terminal or a display of said watch device.

11. The method of claim 7, wherein said wireless data transferring module is RF module or WiFi module.

12. The method of claim 7, wherein said mobile terminal is a cell phone, a smart phone, a Personal Digital Assistant or a tablet PC.

13. A method of contact-less transaction, comprising:
providing a mobile terminal and a watch device which communicates with said mobile terminal;
implanting a contact-less card including a transaction card, a credit card or a cash card into said watch device, wherein said watch device includes a transmitter and a near field communication chip, wherein said watch device is wirelessly contacting to said mobile terminal within a predetermined distance; and
contact-lessly attaching said watch device to a contact-less card reader for transmitting a transaction signal from said transmitter to process a contact-less transaction.

14. The method of claim 13, further comprising generating a security code by a security code generator in said watch device or said mobile terminal.

15. The method of claim 14, wherein said security code is a one time password.

16. The method of claim 13, wherein said transmitter is an antenna or coils set.

17. The method of claim 13, further comprising displaying a transaction information on a display of said mobile terminal or a display of said watch device.

18. The method of claim 13, further comprising downloading a transaction information through a wireless data transferring module of said mobile terminal.

19. The method of claim 13, wherein said mobile terminal is a cell phone, a smart phone, a Personal Digital Assistant or a tablet PC.

20. The method of claim 13, further comprising transferring an image captured by said watch device to said mobile terminal by a wireless data transferring module.
